(19) United States
(12) Patent Application Publication
(10) Pub. No.: US 2018/0058864 A1
(43) Pub. Date: Mar. 1, 2018

(54) METHODS AND SYSTEMS FOR VEHICLE AND DRONE BASED DELIVERY SYSTEM

(71) Applicant: INTERNATIONAL BUSINESS MACHINES CORPORATION, Armonk, NY (US)

(72) Inventors: David B. LECTION, Raleigh, NC (US); Sarbajit K. RAKSHIT, Kolkata (IN); Mark B. STEVENS, Austin, TX (US); John D. WILSON, League City, TX (US)

(73) Assignee: INTERNATIONAL BUSINESS MACHINES CORPORATION, Armonk, NY (US)

(21) Appl. No.: 15/246,966

(22) Filed: Aug. 25, 2016

(51) Int. Cl. G01C 21/34; G06Q 30/06

(52) U.S. Cl. CPC G01C 21/3423; G06Q 50/01; G01C 21/3415; G06Q 30/0631

(57) ABSTRACT

Embodiments for delivering goods to customers by a processor are described. A plurality of goods to be loaded onto a delivery vehicle are selected based on customer-associated information. A delivery route for the delivery vehicle is determined based on the customer-associated information. A customer order for at least one of the selected plurality of goods is received. The at least one of the selected plurality of goods is caused to be delivered from the delivery vehicle on the delivery route to the customer using a drone.

### BACKGROUND OF THE INVENTION

### Field of the Invention

The present invention relates in general to computing systems, and more particularly, to various embodiments for delivering products to customers using vehicle and drone based delivery systems.

### Description of the Related Art

One of the problems expected with the practical implementation of drone (e.g., unmanned aerial vehicle (UAV)) based delivery systems is that the current state of the art drones have limited carrying (or payload) capacity. If multiple products are to be delivered, depending on the size and weight of the products, the drone may have to travel between the warehouse and delivery point several times, or alternatively, multiple drones may have to be used for a single delivery. This problem will most likely be exacerbated by the relatively limited range of the drones.

These problems are expected to increase as drone based delivery systems become more commonly used. As such, there will be a need to reduce delivery times and otherwise increase the efficiency of such delivery systems.

### SUMMARY OF THE INVENTION

Various embodiments for delivering goods to customers by a processor are described. In one embodiment, by way of example only, a method for delivering goods to customers, again by a processor, is provided. A plurality of goods to be loaded onto a delivery vehicle are selected based on customer-associated information. A delivery route for the delivery vehicle is determined based on the customer-associated information. A customer order for at least one of the selected plurality of goods is received. The at least one of the selected plurality of goods is caused to be delivered from the delivery vehicle on the delivery route to the customer using a drone.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a plan view of a map having a delivery route indicated thereon in accordance with aspects of the present invention;

FIG. 5 is a plan view of the map of FIG. 4 after the delivery route has been altered in accordance with aspects of the present invention;

FIG. 6 is a graphical illustration of a method for determining a delivery route for a delivery vehicle in accordance with aspects of the present invention;

FIG. 7 is a plan view of a map interface that may be used to place orders in accordance with aspects of the present invention;

FIG. 8 is a flowchart diagram depicting an exemplary method for delivering goods to customers in which various aspects of the present invention may be implemented; and

FIG. 9 is a flowchart diagram depicting an exemplary method for delivering goods to customers, again in which various aspects of the present invention may be implemented.

### DETAILED DESCRIPTION OF THE DRAWINGS

As previously indicated, as the use of drone based delivery systems increases, the limited carrying capacity and range of the drones is likely to result in undesirable delivery delays and other inefficiencies. This will most likely be a particular problem when customers order multiple products, as it may result in the drone having to travel multiple times between the warehouse and the delivery point and/or the use of multiple drones for a single order. Although delivery delays may be acceptable for larger, more expensive goods, ideally customers will be able to order, for example, smaller, daily necessities and have them delivered on the same day.

For example, in the event a customer breaks his or her sunglasses, which he/she is accustomed to wearing when driving an automobile, ideally he or she would be able to order a new pair and have them delivered directly to their residence within, for example, an hour, to reduce the likelihood that they would have to drive without sunglasses, which may particularly be an issue on bright, sunny days. As another example, in the case of a single parent who requires a necessity for an infant, such as diapers, it would be extremely helpful to the parent if he or she could order diapers and have them delivered directly to their residence in a timely manner, as opposed to them having to leave the house with their infant. Although such delivery systems are anticipated, the overall delivery time and efficiency of the systems seems dubious when a single customer orders both items because, as described above, multiple trips by the drone and/or multiple drones may be required.

In view of the foregoing, a need exists for drone based delivery systems in which overall efficiency is optimized, thereby reducing delivery times, particularly in the cases of multiple-product orders.

To address these needs, the methods and systems of the present invention use, for example, various information about customers in a particular geographic region to select what goods (or products) to load onto one or more delivery vehicles (e.g., ground vehicles, such as driverless trucks) that will be deployed in that geographic region. In other words, goods are loaded onto the delivery vehicle(s) in a particular region based on predicted (or estimated or anticipated) customer orders in that region. In one example, also based on the information about the customers, perhaps in combination with orders that have already been placed, a delivery route for the delivery vehicle(s) is determined in such a way to reduce overall delivery times for the anticipated orders, perhaps as well as the goods associated with previously placed orders, when the goods are delivered to the customers from the delivery vehicle(s) using drones (e.g., unmanned aerial vehicles (UAVs)).

In one example, after an initial delivery route for the delivery vehicle(s) is determined, in response to receiving one or more customer orders for the goods loaded on the delivery vehicle(s), the delivery route(s) is altered to further maximize delivery efficiency (e.g., reduce delivery times as much as possible).

Depending on the goods ordered, as well as their current locations (i.e., the location(s) of the delivery vehicle(s) on which the goods are stored), a single drone may retrieve one product from one delivery vehicle, and then travel to other delivery vehicles to retrieve other products, before making the delivery at the delivery point (e.g., the customer's shipping address). In some embodiments, the drones are stored on the delivery vehicles when not in use, but it is also contemplated that the drones may be stored at other locations, such as the customers' residences (i.e., the drone used to deliver the order may belong to the customer).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge of the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

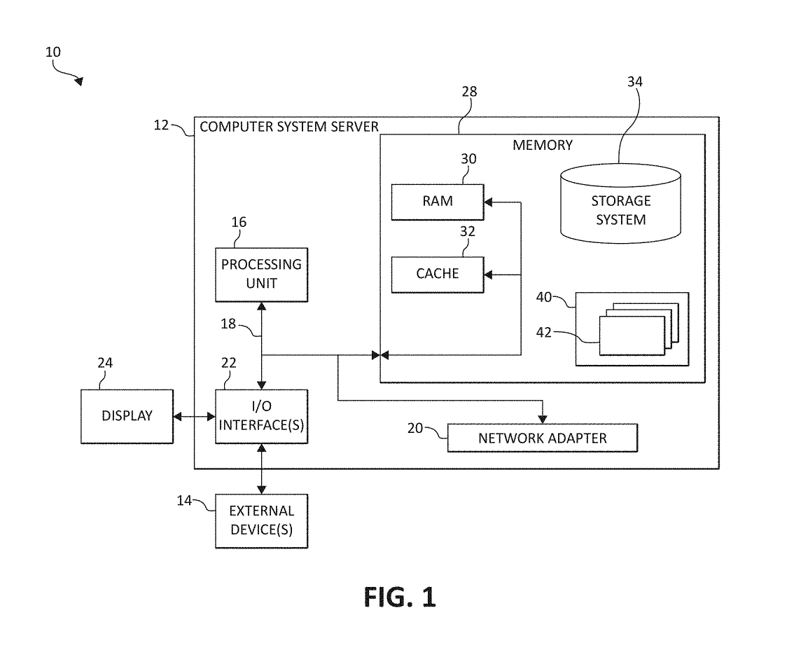

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, hand-held or laptop devices, and network PCs. However, in some embodiments, some of the components depicted in FIG. 1 may be located in a delivery vehicle (e.g., a driverless ground vehicle) and/or a drone (e.g., UAV). For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

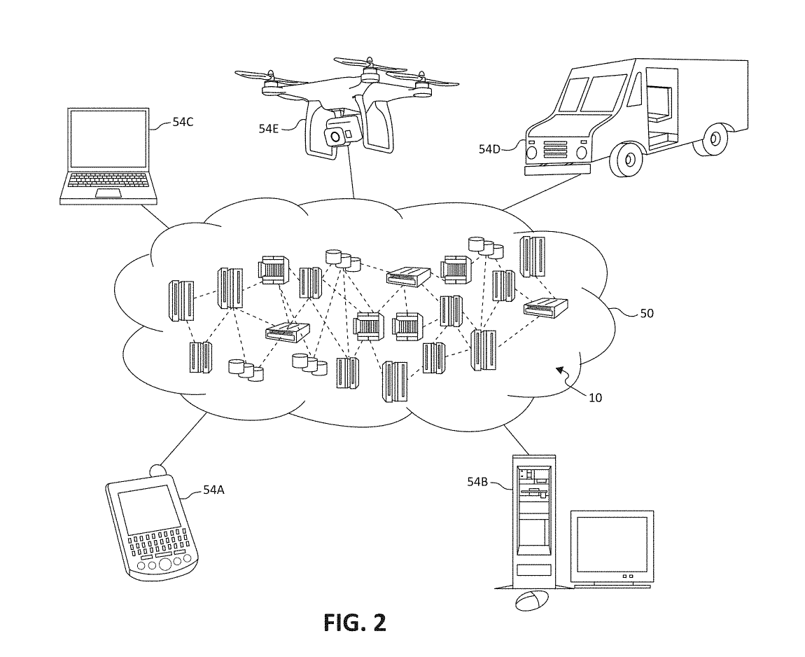

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, and/or laptop computer 54C, and delivery computer systems, such as, for example, those on delivery vehicle(s) 54D and/or drone(s) 54E, may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-E shown in FIG. 2 are intended to be illustrative only and that computing nodes 10 and cloud computing environment 50 can communicate with any type of computerized device over any type of network and/or network addressable connection (e.g., using a web browser).

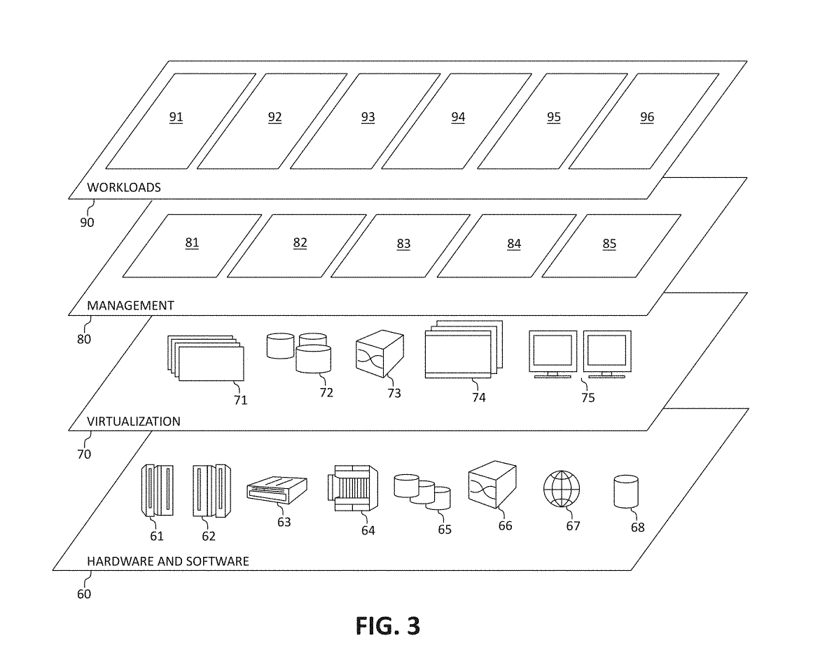

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various route determination workloads and functions 96 for determining initial delivery routes of both delivery vehicles and drones, as well as altering the routes in real-time in response to receiving customer orders. One of ordinary skill in the art will appreciate that the image processing workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the methods and systems of the illustrated embodiments provide novel approaches for delivering goods to customers. The methods and systems include a data collection aspect, where a variety of information (i.e., customer-associated information) may be collected about customers (and/or potential customers) for goods in, for example, a particular geographic region. The information may include and/or be based on, for example, the internet browsing data and social media interaction associated with the customers, as well as the customers' age, gender, purchase history, spending habits, and participation in a buying program/club. Additionally, the information may include, for example, the current date/season and weather data (e.g., temperature, chance of participation, etc.).

Based on the collected data, a delivery vehicle (or mobile warehouse) is loaded with a plurality of selected goods that are considered likely to be purchased by customers in the geographic region in which the delivery vehicle is deployed. In one example, the customer-associated information is also used to determine an initial route that is used by the delivery vehicle. The initial delivery route may be chosen in such a way to maximize the efficiency of the delivery of goods of estimated orders. In one example, the initial route is also based on orders that have already been placed by customers in that particular region. It should be understood that the initial route may include simply positioning the delivery vehicle at a particular location in the region, as opposed to having the delivery vehicle in constant or near constant motion along a specified route in the region. Additionally, other information, such as road information (e.g., maps) and traffic information (e.g., traffic events, alerts, and the like), may be used further optimize the delivery route.

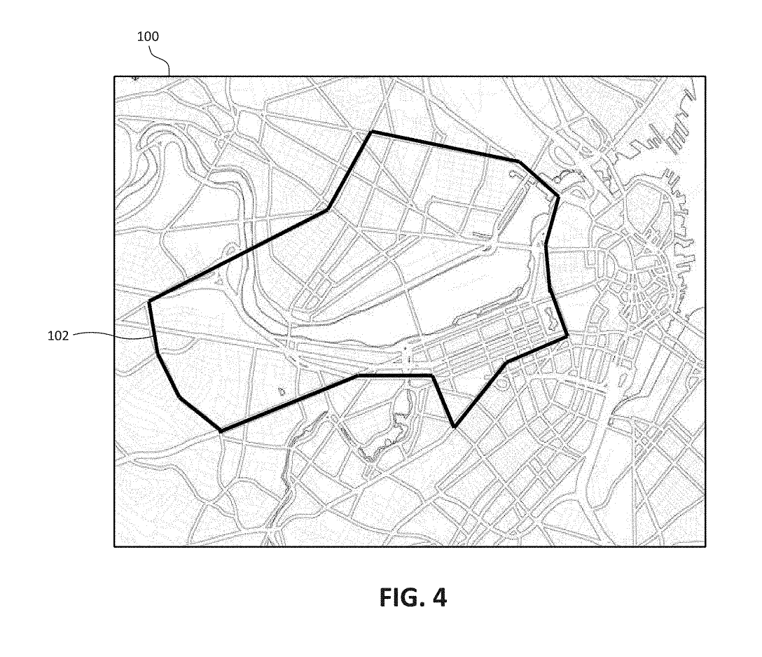

Referring to FIG. 4, a map 100 of a particular geographic region, having multiple roads/roadways, is shown. A delivery route (e.g., an initial delivery route) 102 is indicated on the map 100 as following selected roads in what is essentially a loop around the region. As described above, the delivery route 102 may be determined based on various information about customers (or potential customers), as well as information about the roads/traffic and orders that have already been received and processed. Although only one delivery route 102 is shown, it should be understood that multiple delivery routes may be simultaneously used within a particular region (i.e., multiple delivery vehicles may be simultaneously deployed and dispersed within the region).

When a customer order is received (and/or processed), one or more drones are used to transport the ordered goods from the delivery vehicle to the customer (e.g., the customer's shipping address). The drone(s) may be stored on the delivery vehicle when not in use. In this regard, although not shown, the delivery vehicle may have storage bays for the drone and/or landing areas for the drones. The delivery vehicles may also be equipped with conveyer belt-like systems and/or other automated mechanisms to transfer the ordered products to a location suitable to be retrieved by the drones (e.g., the landing areas), perhaps in a particular order (e.g., based on the order in which the orders were placed/received and/or the order in which the products will be retrieved by the drones) so that the products are ready to be picked up by the drones without any delay.

In one example, the drone is stored at the customer's shipping address (e.g., the drone is owned by the customer) and is deployed from the customer's address, retrieves the ordered goods from the delivery vehicle, and returns to the customer's address. Also, for multiple product orders in which the ordered products are stored on different delivery vehicles, a drone may retrieve one product from one delivery vehicle, carry it to another delivery truck, retrieve a second (or third, etc,) product from another delivery vehicle, and then deliver multiple products to the delivery point at once. Further, in situations in which the ordered product(s) is relatively far from the delivery point, a drone may retrieve a product from one delivery truck and carry it to another delivery truck, where is it retrieved by another drone to be taken to the delivery point.

In one example, if the drone encounters a technical issue while attempting to deliver a product, the drone may return to the delivery vehicle from which the product was picked up (or another delivery vehicle), and the system will schedule a new delivery with another drone. Additionally, the drones may be used to transfer products from one delivery vehicle to another based on dynamic need (e.g., predicted inventory and/or purchasing patterns that suggest particular products are popular in particular areas). In this manner, inventory may be moved between delivery vehicles based on predicted future orders.

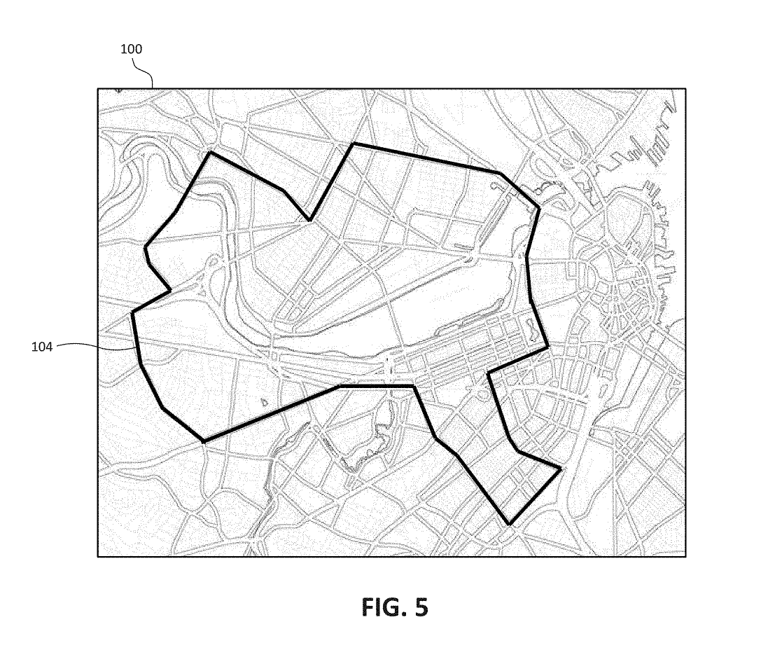

In one example, when customer orders are received after the delivery vehicle has already been deployed (or at least after the initial delivery route is determined), the delivery route is altered in order to reduce delivery times and/or otherwise optimize delivery efficiency. For example, FIG. 5 shows the same map as was shown in FIG. 4 but with an altered delivery route 104 (i.e., altered from the initial delivery route 102 shown in FIG. 4). In the examples shown in FIG. 4 and FIG. 5, the changes to the delivery route may be made in response to, for example, customer orders with delivery points (e.g., shipping addresses) in the upper, left and lower, right portions of the region shown in the map 100. It should be understood that the changes to the delivery route may be made in “real-time” in response customer orders that are received. As such, the delivery route may be updated (or altered) repeatedly and/or continuously while the delivery vehicle is deployed.

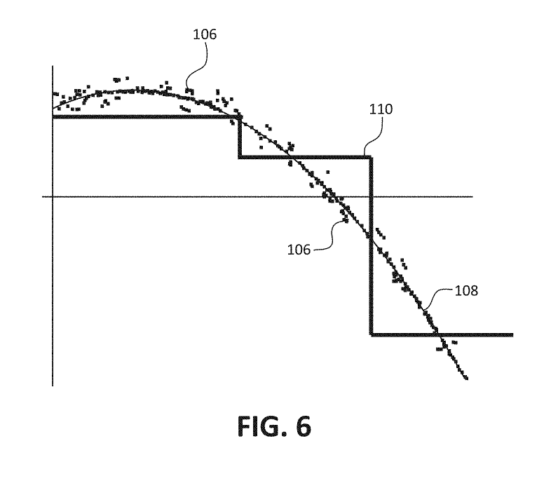

FIG. 6 shows a graphical illustration of a method that, in one example, is used to determine the delivery route(s) (e.g., the initial delivery route and/or the altered delivery route) of the delivery vehicle(s). In one example, a “least squares fitting” method is used to determine the delivery route(s), as will be appreciated by one skilled in the art. As depicted in FIG. 6, each dot 106 may be considered to represent a customer order (e.g., a predicted customer order or a previously received customer order), or more particularly, represents the shipping address, or delivery point, associated with a customer order. Line 108 may be considered to represent the “least squares fitting” line generated based on the customer orders. Line 110 may be considered to represent the delivery route that is determined to be the most effective with respect to overall delivery time, efficiency, etc. As such, line 108 may be considered to represent the “ideal” delivery route based on the customer orders (i.e., predicted and/or received) at any given time. However, because of various factors, such as the layout of roads, traffic conditions, etc., the actual delivery route (line 110) may not perfectly follow the ideal delivery route (line 108). Again, it should be understood that the delivery route (line 110) may be dynamically adjusted in real-time in response to updates made to the customer orders (dots 106).

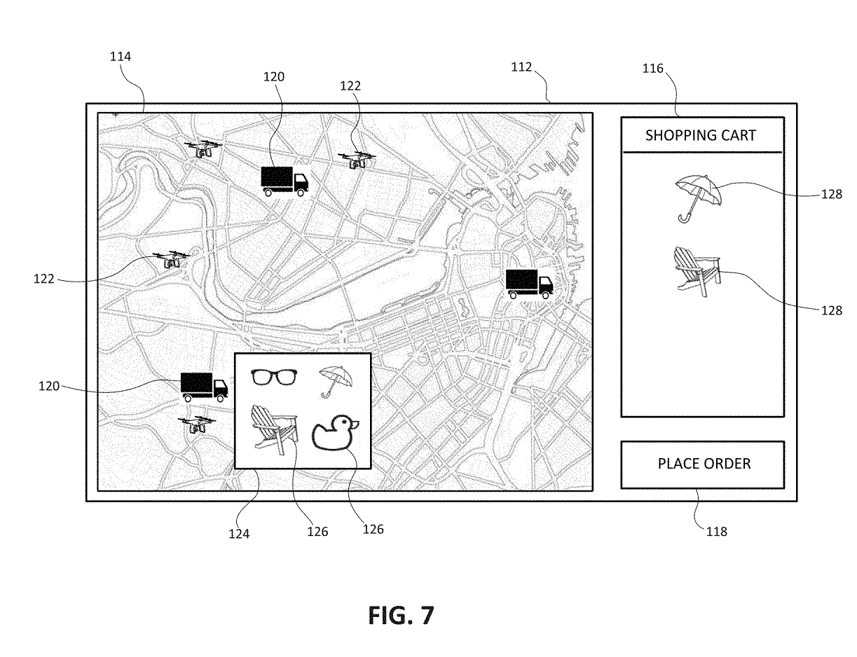

FIG. 7 illustrates an example of a map interface screen 112 that may be displayed to a user (e.g., a potential customer) via, for example, a cellular telephone, a desktop computer, or laptop computer in order to facilitate customer orders. In the depicted embodiment, the map interface screen 112 includes a map 114 (e.g., similar to map 100 shown in FIG. 4 and FIG. 5), a shopping cart window 116, and an order button 118. As in FIG. 4 and FIG. 5, the map 114 represents a particular geographic area, such as the region in which the user lives. In the depicted embodiment, on the map 114 are displayed delivery vehicle icons 120 that represent, for example, the real-time locations of delivery vehicles in the region represented by the map 114. In one example, drone icons 122 are also displayed on the map 114, which likewise represent the real-time locations of the drones in the region.

In one example, the user may select one of the delivery vehicles by “clicking” or “mousing over” one of the delivery vehicle icons 120, and in response, an available product window 124 is displayed (e.g., as a pop-window) on the map 114 near the respective delivery vehicle icon 120. In the available product window 124, products (or icons representative of those products and/or an alphanumeric list of those products) 126 are displayed, which are available for sale and loaded on that particular delivery vehicle. In some embodiments, the user may “drag and drop” products 126 from the available product window 124 into the shopping cart window 116, which will then appear in the shopping cart window 116 as selected products 128 (e.g., by displaying products icons and/or an alphanumeric list of the products in the shopping cart window 116). It should be understood that different delivery vehicles in the region may be loaded with different products/goods. As such, the user may similarly select the other delivery vehicle icons 120 on the map 114 for additional products they wish to order.

When the user has all of the desired products in the shopping cart window 116, the user may click or select the order button 118. In some embodiments, additional steps may be required to complete the order (e.g., arranging for payment, verifying shipping address, etc.). After the user places the order, and the order is received and processed, the ordered goods maybe delivered to the customer as described above (e.g., transported from the delivery vehicle to the delivery point via a drone).

In one example, after placing the order, or perhaps before the order is placed with one or more selected products in the shopping cart window 116, the user is provided with an indication of recommended (or suggested) products that, for example, are available on the same delivery vehicle from which their current order will originate. The suggested products may be based in part on, for example, the size and weight of the product(s) already ordered and payload space and capacity of the drone that will deliver the product(s). Additionally, the suggested products may be based on information associated with that particular customer (e.g., previous orders, browsing history, etc.) and/or other information (e.g., weather conditions, time of day, date, etc.). Although not shown, the indication of the suggested products may be provided via, for example, a pop-up window on the map interface screen 112 (e.g., similar to the available product window 124), a subsequent screen (e.g., during arrangement for payment), a personal message (e.g., email or text message), etc.

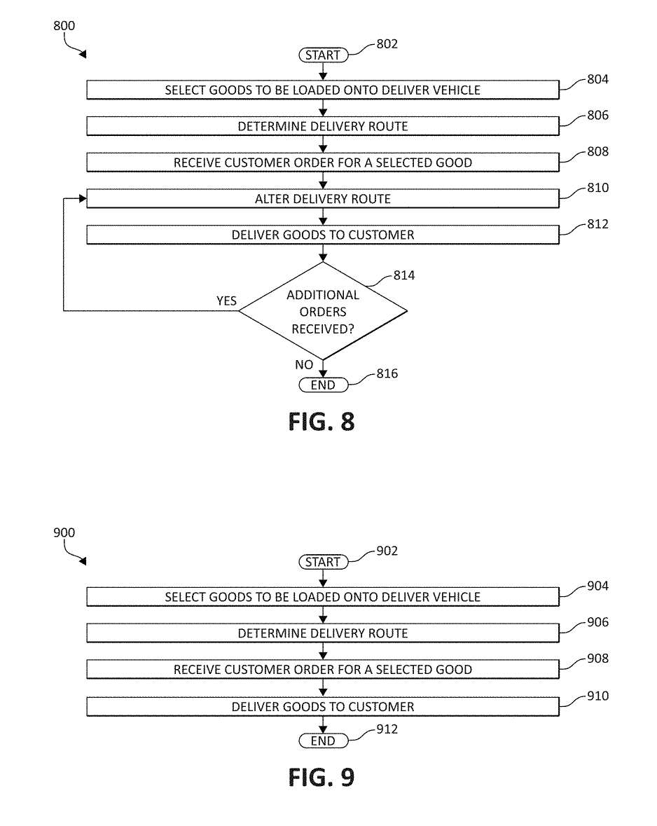

Turning to FIG. 8, a flowchart diagram of an exemplary method 800 for delivering goods to customers, in accordance with various aspects of the present invention, is illustrated. Method 800 begins (step 802) with the selection of a plurality of goods to be loaded onto a delivery vehicle(s) in the manner(s) described above, such as based on customer-associated information (step 804). A delivery route (e.g., an initial delivery route) for the delivery vehicle(s) is then determined as described above, such as based on customer-associated information and/or the selected goods (step 806). As described above, the selected goods and the (initial) delivery route may also be based on customer orders that have already been placed.

Still referring to FIG. 8, a customer order for one or more of the selected goods loaded on the delivery vehicle(s) is then received, perhaps after the delivery vehicle(s) have been deployed (step 808). The delivery route is then altered based on the customer order (step 810). The goods associated with the customer order are then delivered to the customer using, for example, drones, as described above (step 812). If additional customer orders are received, method 800 returns to step 810 where the delivery route is (again) altered based on the newly received customer orders (step 814). If no additional customer orders are received, method 800 ends (step 816), with, for example, the delivery truck continuing on the current delivery route and/or returning to the warehouse or station from which it originated.

It should be understood that in some embodiments the methods for delivering goods to customers described herein may not include all of the steps depicted in FIG. 8. As such, referring to FIG. 9, a flowchart diagram of an exemplary method 900, having fewer steps than is depicted in FIG. 8, for delivering goods to customers, in accordance with various aspects of the present invention, is illustrated. Method 900 begins (step 902) with the selection of a plurality of goods to be loaded onto a delivery vehicle(s) in the manner(s) described above, such as based on customer-associated information (step 904). A delivery route for the delivery vehicle(s) is then determined as described above, such as based on customer-associated information and/or the selected goods (step 906). As described above, the selected goods and the (initial) delivery route may also be based on customer orders that have already been placed. A customer order for one or more of the selected goods loaded on the delivery vehicle(s) is then received, perhaps after the delivery vehicle(s) have been deployed (step 908). The goods associated with the customer order are then delivered to the customer using, for example, drones, as described above (step 910). Method 900 ends (step 912), with, for example, the delivery truck continuing on the current delivery route and/or returning to the warehouse or station from which it originated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for delivering goods to customers, comprising:
selecting a plurality of goods to be loaded onto a delivery vehicle based on customer-associated information;
determining a delivery route for the delivery vehicle based on the customer-associated information;
receiving a customer order for at least one of the selected plurality of goods; and
causing the at least one of the selected plurality of goods to be delivered from the delivery vehicle on the delivery route to the customer using a drone.

2. The method of claim 1, wherein the receiving of the customer order occurs after the selecting of the plurality of goods and the determining of the delivery route.

3. The method of claim 2, further including altering the delivery route based on the customer order, and wherein the causing of the at least one of the selected plurality of goods to be delivered from the delivery vehicle to the customer includes causing the at least one of the selected plurality of goods to be delivered from the delivery vehicle on the altered delivery route to the customer using the drone.

4. The method of claim 1, wherein the customer-associated information includes at least one of browsing data or social media interaction.

5. The method of claim 1, further including displaying a list of at least some of the selected plurality of goods to the customer before receiving the customer order.

6. The method of claim 1, further including, after receiving the customer order, displaying a list of recommended goods to the customer based on at least one of the selected plurality of goods or the customer-associated information.

7. The method of claim 1, wherein the delivery vehicle is a driverless ground vehicle and the drone is an unmanned aerial vehicle (UAV).

8. A system for delivering goods to customers, comprising:
a processor that
selects a plurality of goods to be loaded onto a delivery vehicle based on customer-associated information;
determines a delivery route for the delivery vehicle based on the customer-associated information;
receives a customer order for at least one of the selected plurality of goods; and
causes the at least one of the selected plurality of goods to be delivered from the delivery vehicle on the delivery route to the customer using a drone.

9. The system of claim 8, wherein the processor receives the customer order after selecting of the plurality of goods and determining of the delivery route.

10. The system of claim 9, wherein the processor alters the delivery route based on the customer order, and wherein the causing of the at least one of the selected plurality of goods to be delivered from the delivery vehicle to the customer includes causing the at least one of the selected plurality of goods to be delivered from the delivery vehicle on the altered delivery route to the customer using the drone.

11. The system of claim 8, wherein the customer-associated information includes at least one of browsing data or social media interaction.

12. The system of claim 8, wherein the processor displays a list of at least some of the selected plurality of goods to the customer before receiving the customer order.

13. The system of claim 8, wherein the processor, after receiving the customer order, displays a list of recommended goods to the customer based on at least one of the selected plurality of goods or the customer-associated information.

14. The system of claim 8, wherein the delivery vehicle is a driverless ground vehicle and the drone is an unmanned aerial vehicle (UAV).

15. A computer program product for delivering goods to customers by a processor, the computer program product comprising a non-transitory computer-readable storage medium having computer-readable program code portions stored therein, the computer-readable program code portions comprising:
an executable portion that
selects a plurality of goods to be loaded onto a delivery vehicle based on customer-associated information;
determines a delivery route for the delivery vehicle based on the customer-associated information;
receives a customer order for at least one of the selected plurality of goods; and
causes the at least one of the selected plurality of goods to be delivered from the delivery vehicle on the delivery route to the customer using a drone.

16. The computer program product of claim 15, wherein the receiving of the customer order occurs after the selecting of the plurality of goods and the determining of the delivery route.

17. The computer program product of claim 16, further including an executable portion that alters the delivery route based on the customer order, and wherein the causing of the at least one of the selected plurality of goods to be delivered from the delivery vehicle to the customer includes causing the at least one of the selected plurality of goods to be delivered from the delivery vehicle on the altered delivery route to the customer using the drone.

18. The computer program product of claim 15, wherein the customer-associated information includes at least one of browsing data or social media interaction.

19. The computer program product of claim 15, further including an executable portion that displays a list of at least some of the selected plurality of goods to the customer before receiving the customer order.

20. The computer program product of claim 15, further including an executable portion that, after the customer order is received, displays a list of recommended goods to the customer based on at least one of the selected plurality of goods or the customer-associated information.

21. The computer program product of claim 15, wherein the delivery vehicle is a driverless ground vehicle and the drone is an unmanned aerial vehicle (UAV).
